(19) United States
(12) Patent Application Publication
(10) Pub. No.: US 2008/0044793 A1
(43) Pub. Date: Feb. 21, 2008

(54) Simulated teeth coverings

(76) Inventor: Jonah White, Michael, IL (US)

Correspondence Address: HARNESS, DICKEY, & PIERCE, P.L.C, 7700 BONHOMME, STE 400, ST. LOUIS, MO, 63105, US

(21) Appl. No.: 11/512,536

(22) Filed: Aug. 30, 2006

Related U.S. Application Data
(63) Continuation-in-part of application No. 29/264,142, filed on Aug. 3, 2006, now Pat. No. D555793.

(51) Int. Cl. A61C 13/00

(52) U.S. Cl. 433/171

(57) ABSTRACT

According to various aspects, exemplary embodiments are provided of simulated teeth coverings. In one exemplary embodiment, a simulated teeth covering generally includes a forward surface and a rearward surface. At least one hole extends generally from the rearward surface to the forward surface.

### CROSS-REFERENCE TO RELATED APPLICATION

This application is a continuation-in-part of U.S. patent application Ser. No. 29/264,142 filed Aug. 3, 2006. The disclosure of the above application is incorporated herein by reference.

### FIELD

The present disclosure relates generally to simulated teeth coverings.

### BACKGROUND

The statements in this background section merely provide background information related to the present disclosure and may not constitute prior art.

Many people like to change their external appearance, for example, while trick-or-treating at Halloween or attending a costume party. While it is common for people to wear masks, some people prefer wearing fake teeth, such as those commercially available from Billy-Bob Teeth, Inc. of Hardin, Ill. In this regard, FIGS. 1 through 4 generally represent one of the many Billy-Bob® teeth designs commercially available from Billy-Bob Teeth, Inc. As shown in FIGS. 1 through 4, the fake teeth 10 include a forward surface 20 configured to resemble a human's natural teeth structure. The fake teeth 10 also include a bottom shelf or trough portion 40 having downwardly-extending holes 50 therethrough.

The holes 50 can be used along with re-moldable fitting material (e.g., thermal fitting plastic beads commercially available from Billy-Bob Teeth, Inc., etc.) for retaining the fake teeth 10 to the user's existing teeth structure (e.g., teeth, caps or crowns on the teeth, etc.). For purposes of illustration only, the following description is provided of an exemplary method for fitting the fake teeth 10 to a user's existing upper teeth structure by using the holes 50 and re-moldable fitting material.

In this exemplary method, re-moldable fitting material is heated until the re-moldable fitting material changes from its initial white color to substantially clear. By way of example only, the re-moldable fitting material can be heated by placing it into a cup of boiling or very hot water. Depending on the water temperature, it may take approximately one minute for the color change to occur in the re-moldable fitting material. After the color change, the re-moldable fitting material is removed from the hot water, such as with a spoon. The user then molds or rolls the re-moldable fitting material into a generally worm-like shape. The re-moldable fitting material in the worm-like shape is placed into the fake teeth's trough portion 40. Pressure is applied to the re-moldable fitting material (e.g., by using the fingers, etc.) to squeeze or force some of the re-moldable fitting material downwardly through the holes 50 in the fake teeth's trough portion 40. The fake teeth 10 is placed into the user's mouth. The user's existing teeth are moved relatively towards the fake teeth's trough portion 40 through re-moldable fitting material within the trough portion 40. This relative movement continues until the user's existing teeth contacts the lower surface 42 of the fake teeth's trough portion 40. Excess re-moldable fitting material is pushed against the roof of the user's mouth (e.g., by using the tongue, etc.). The fake teeth 10 is brought tightly against the user's existing teeth structure to form an impression thereof in the re-moldable fitting material. The fake teeth 10 is gently removed from the user's mouth, and allowed to cool for at least about ten minutes. During this cooling process, the re-moldable fitting material may change in color back to its initial white color. If the user is not satisfied with the end result (e.g., the impression, etc.), this process may be repeated until a satisfactory result is achieved. At which point, the satisfied user may remove or trim excess re-moldable fitting material from the fake teeth 10. During the exemplary process described in this paragraph, the user should not leave the fake teeth 10 in his or her mouth for more than one minute, so as to avoid having the re-moldable fitting material cool and harden while in the user's mouth. If that happens, hot water or a dentist may be needed to remove the fake teeth 10 from the user's mouth.

### SUMMARY

According to various aspects, exemplary embodiments are provided of simulated teeth coverings. In one exemplary embodiment, a simulated teeth covering generally includes a forward surface and a rearward surface. At least one hole extends generally from the rearward surface to the forward surface.

Other aspects of the present disclosure relate to methods of attaching a simulated teeth covering to a user's existing teeth structure. In one exemplary embodiment, a method generally includes engagingly receiving at least a portion of the user's existing teeth structure within an impression formed in a first portion of re-moldable fitting material on a rearward surface of the simulated teeth covering. The re-moldable fitting material also includes a second portion disposed within at least one hole extending generally from the simulated teeth covering's forward surface to the rearward surface, thereby at least partially forming at least one bond mechanically retaining the re-moldable fitting material to the simulated teeth covering. The at least one bond and the engagement of the at least a portion of the user's existing teeth structure within the impression can cooperatively retain the simulated teeth covering to the user's existing teeth structure.

Additional aspects of the present disclosure relate to methods of making simulated teeth coverings. In one exemplary embodiment, a method generally includes forming at least one hole extending generally from the simulated teeth covering's rearward surface to the simulated teeth covering's forward surface.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

The drawings described herein are for illustration purposes only and are not intended to limit the scope of the present disclosure in any way.

FIG. 1 is an upper forward perspective view of fake teeth having a bottom trough portion with downwardly-extending holes therethrough;

FIG. 2 is a front elevation view of the fake teeth shown in FIG. 1;

FIG. 3 is an upper plan view of the fake teeth shown in FIG. 1;

FIG. 4 is a lower plan view of the fake teeth shown in FIG. 1;

FIG. 5 is an upper forward perspective view of a simulated teeth covering having holes extending generally from the simulated teeth covering's forward surface to the rearward surface according to exemplary embodiments;

FIG. 6 is a lower rearward perspective view of the simulated teeth covering shown in FIG. 5;

FIG. 7 is a front elevation view of the simulated teeth covering shown in FIG. 5;

FIG. 8 is a back elevation view of the simulated teeth covering shown in FIG. 5;

FIG. 9 is a left side elevation view of the simulated teeth covering shown in FIG. 5;

FIG. 10 is a right side elevation view of the simulated teeth covering shown in FIG. 5;

FIG. 11 is an upper plan view of the simulated teeth covering shown in FIG. 5;

FIG. 12 is a lower plan view of the simulated teeth covering shown in FIG. 5;

FIG. 13 is an exploded perspective view of the simulated teeth covering shown in FIG. 5 and re-moldable fitting material that can be used for retaining the simulated teeth covering to a user's mouth according to exemplary embodiments; and

FIG. 14 is a cross-sectional view of the simulated teeth covering and re-moldable fitting material shown in FIG. 13 being retained to the user's existing teeth structure, and also illustrating an exemplary bond mechanically retaining the re-moldable fitting material (some of which is within the simulated teeth covering's holes) to the simulated teeth covering and the frictional engagement of the user's existing teeth structure within an impression formed in the re-moldable fitting material according to exemplary embodiments.

### DETAILED DESCRIPTION

The following description is merely exemplary in nature and is in no way intended to limit the present disclosure, application, or uses.

According to various aspects, exemplary embodiments are provided of simulated teeth coverings. In one exemplary embodiment, a simulated teeth covering generally includes a forward surface and a rearward surface. At least one hole extends generally from the rearward surface to the forward surface.

Some embodiments include re-moldable fitting material having a first portion disposed on at least a portion of the simulated teeth covering's rearward surface, a second portion disposed within the at least one hole, and a third portion disposed on at least a portion of the simulated teeth covering's forward surface. Accordingly, at least one bond can be formed thereby for mechanically retaining the re-moldable fitting material to the simulated teeth covering.

The first portion of the re-moldable fitting material can also include an impression of at least a portion of a user's existing teeth structure for frictional engagement therewith. In such embodiments, the at least one bond and the frictional engagement of the at least a portion of the user's existing teeth structure within the impression can thus cooperatively retain the simulated teeth covering to the user's existing teeth structure.

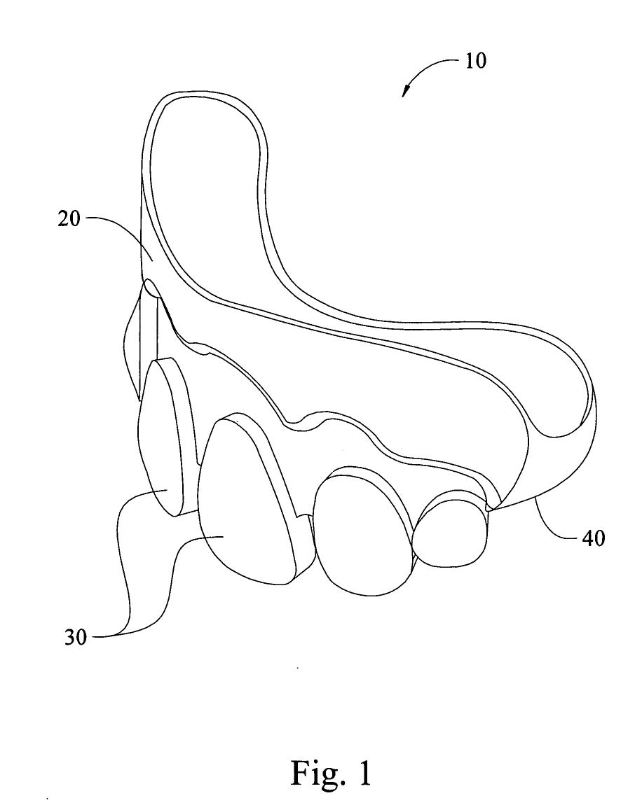

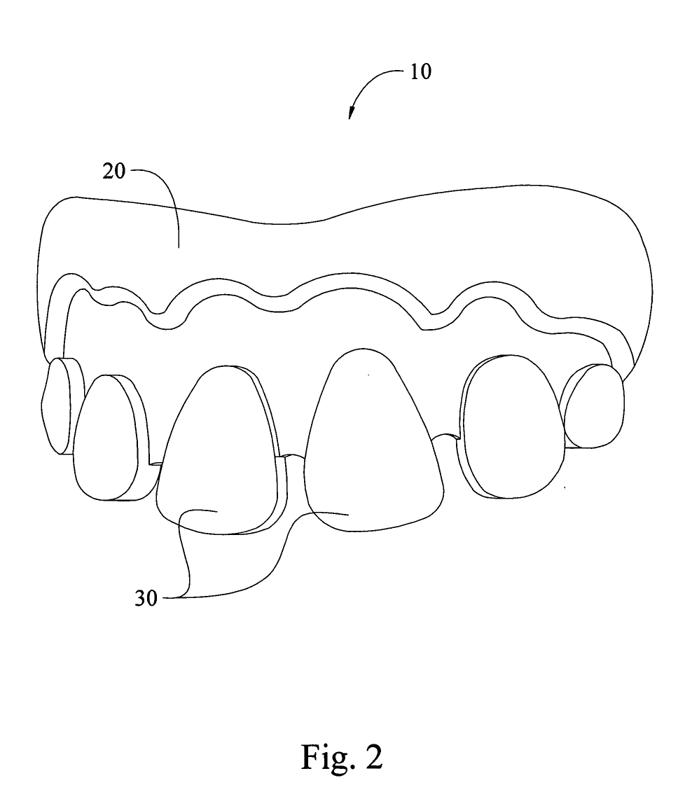

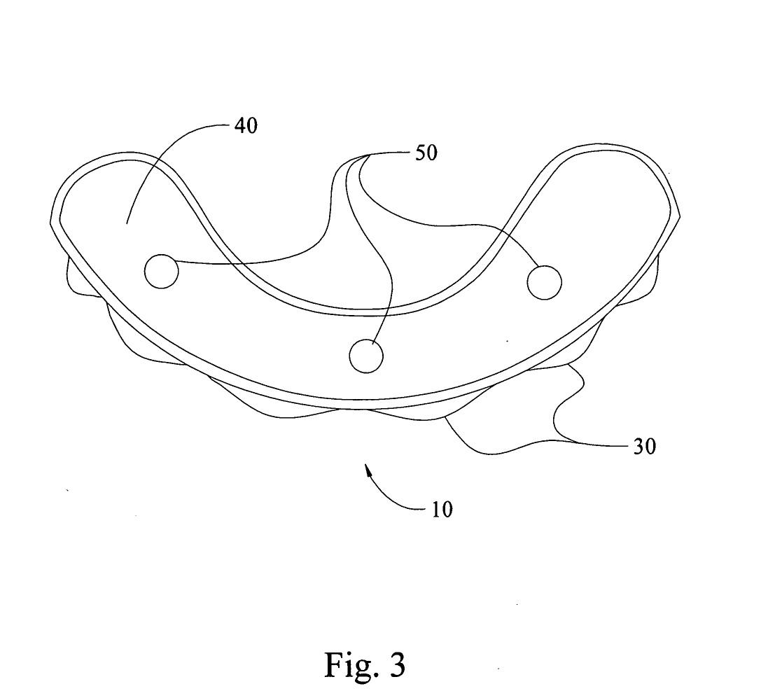

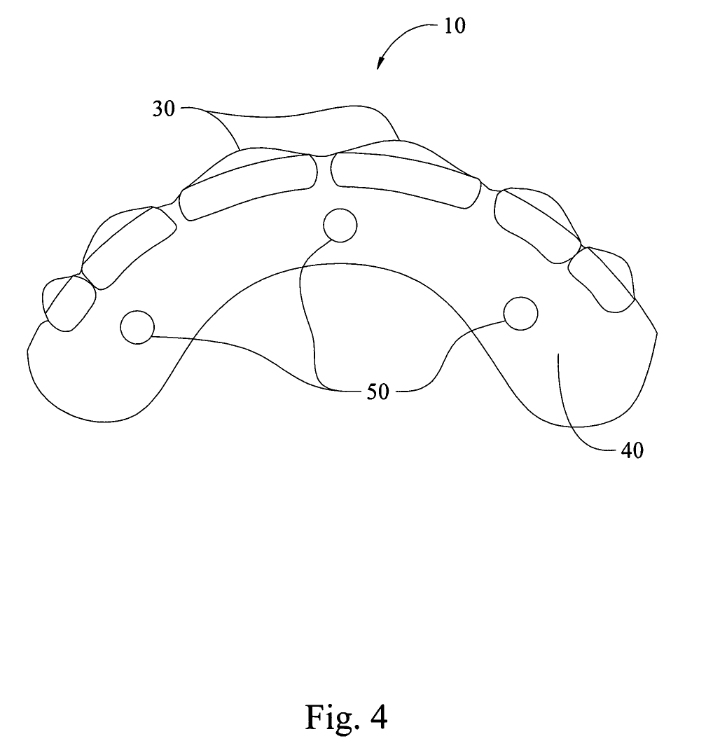

In some embodiments, the simulated teeth covering may define a generally C-shape when viewed from above or below. For example, the simulated teeth covering may include top and bottom edges with substantially identical C-shaped curvatures when respectively viewed from above and below. In such embodiments, the simulated teeth covering does not include a bottom trough portion. This is unlike the fake teeth 10 shown in FIGS. 1 through 4 as having a bottom trough portion 40.

The simulated teeth covering's forward surface may be configured to resemble a human teeth structure. For example, the simulated teeth covering may include one or more substantially white portions configured to resemble one or more human teeth, and/or one or more substantially pink portions configured to resemble human gums. By way of further example, the simulated teeth covering may include a forward surface having a plurality of tooth-resembling portions. In such exemplary embodiments, there may be at least one hole with a forward-facing opening at about the interface between an adjacent pair of the tooth-resembling portions (the most rearward pair in some preferred embodiments).

The simulated teeth covering may include a first end portion, a second end portion, and a medial portion. The medial portion may curve generally from the first end portion to the second end portion. The medial portion may have a curvature that corresponds to the curvature of human teeth structure. In such embodiments, there may be a first hole adjacent the first end portion, and a second hole adjacent the second end portion.

Other aspects of the present disclosure relate to methods of attaching a simulated teeth covering to a user's existing teeth structure. In one exemplary embodiment, a method generally includes engagingly receiving at least a portion of the user's existing teeth structure within an impression formed in a first portion of re-moldable fitting material on a rearward surface of the simulated teeth covering. The re-moldable fitting material also includes a second portion disposed within at least one hole extending generally from the simulated teeth covering's forward surface to the rearward surface, thereby at least partially forming at least one bond mechanically retaining the re-moldable fitting material to the simulated teeth covering. The at least one bond and the engagement of the at least a portion of the user's existing teeth structure within the impression can cooperatively retain the simulated teeth covering to the user's existing teeth structure.

In some embodiments, the method may include heating the re-moldable fitting material, and positioning the heated re-moldable fitting material generally against the rearward surface of the simulated teeth covering with sufficient pressure for causing at least a portion of the heated re-moldable fitting material to enter the at least one hole. The method may include making an impression in the heated re-moldable fitting material on the rearward surface by contacting the same against at least a portion of the user's existing teeth structure. The method may include applying sufficient pressure to the heated re-moldable fitting material such that at least a portion thereof is forced into and out of the at least one hole onto the forward surface of the simulated teeth covering. The method may include shaping the heated re-moldable fitting material into a generally worm-like shape before positioning the heated re-moldable fitting material generally against the simulated teeth covering's rearward surface. The method may include removing the simulated teeth covering from the user's mouth after making the impression, and then allowing the heated re-moldable fitting material to cool. In some embodiments, the method may include heating the simulated teeth covering, and then positioning the heated simulated teeth covering against the user's existing teeth structure to impart a curvature to the simulated teeth covering corresponding to the curvature of the user's existing teeth structure.

Additional aspects of the present disclosure relate to methods of making simulated teeth coverings. In one exemplary embodiment, a method generally includes forming at least one hole extending generally from the simulated teeth covering's rearward surface to the simulated teeth covering's forward surface.

In some embodiments, the at least one hole may be drilled by hand or by an automated process. Alternatively, the at least one hole may be formed during an injection molding process used for making the simulated teeth covering.

The method may include coloring the forward surface of the simulated teeth covering, where the coloring is consistent with a human teeth structure, such as the teeth and gums. The method may include heating re-moldable fitting material, and positioning the heated re-moldable fitting material generally against the rearward surface of the simulated teeth covering with sufficient pressure for causing at least a portion of the heated re-moldable fitting material to enter the at least one hole. The method may include applying sufficient pressure to the heated re-moldable fitting material such that at least a portion thereof is forced into and through the at least one hole onto the forward surface of the simulated teeth covering. The method may include making an impression in the heated re-moldable fitting material on the rearward surface of the simulated teeth covering through contact with at least a portion of the user's existing teeth structure. The method may include heating the simulated teeth covering, and positioning the heated simulated teeth covering against the user's existing teeth structure to impart a curvature to the simulated teeth covering corresponding to the curvature of the user's existing teeth structure.

Alternatively, other means can be employed for retaining the simulated teeth covering to the user's existing teeth structure. For example, a simulated teeth covering may be retained to the user's existing teeth structure using other suitable materials (e.g., adhesives, glue, etc.) besides re-moldable fitting materials or plastic thermal beaded materials commercially available from Billy-Bob Teeth, Inc. Other types of bonds may also be formed besides mechanical or interlocking bonds as disclosed herein. By way of example, other embodiments may include one or more chemical-type bonds, molecular bonds, adhesion bonds, heat-induced bonds, cohesive bonds, adhesive bonds, glues, etc. Accordingly, various embodiments can include chemical bonds, physical bonds, combinations thereof, among other suitable bonds. In some exemplary embodiments, a chemical-type bond may be formed between the simulated teeth covering and the fitting material depending at least in part on the particular materials and the manufacturing processes used. In addition, a bond may be formed generally between a simulated teeth covering and a fitting material that is at least partially self-contained in that portions of the simulated teeth covering and fitting material themselves may be used to form at least a portion of the bond, although such is not required.

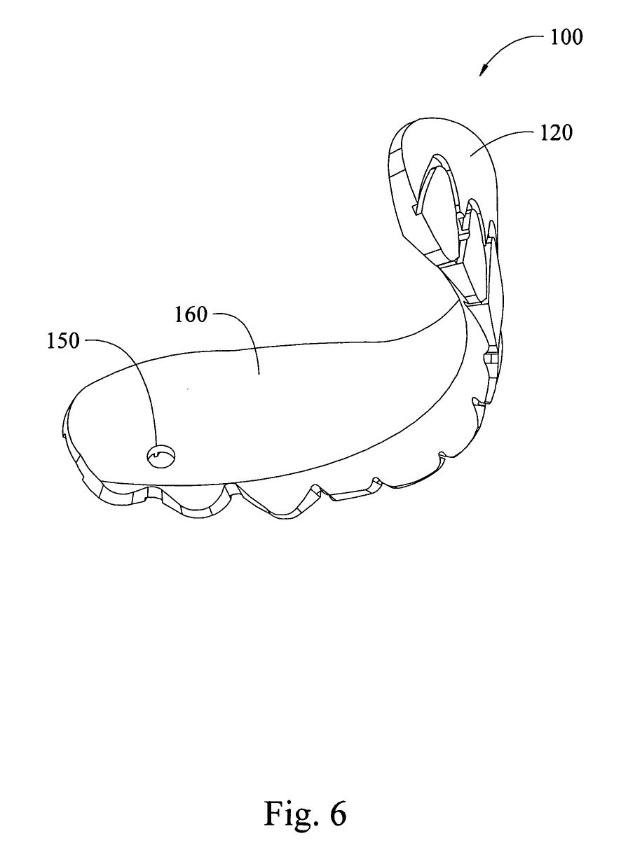

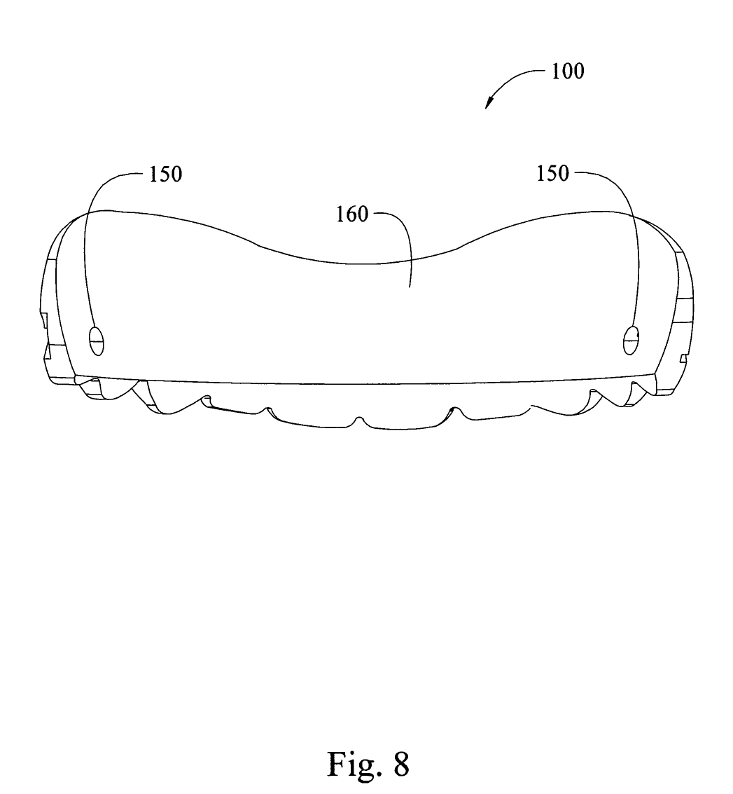

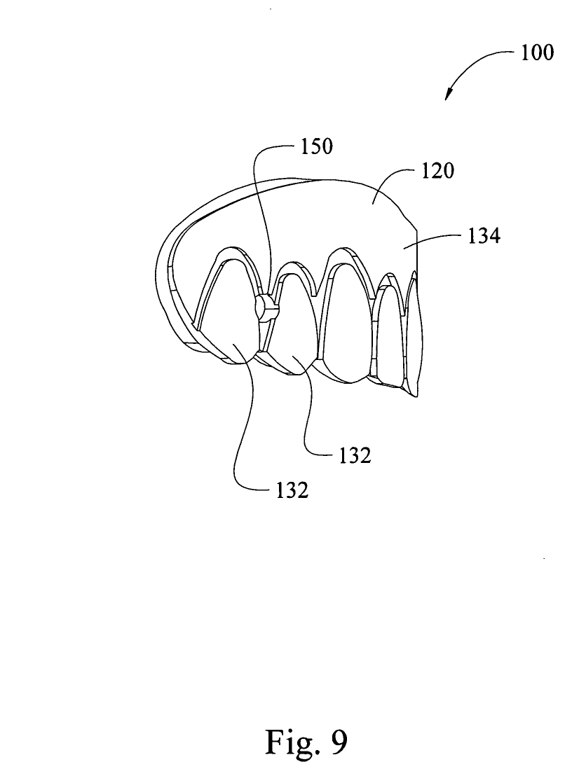

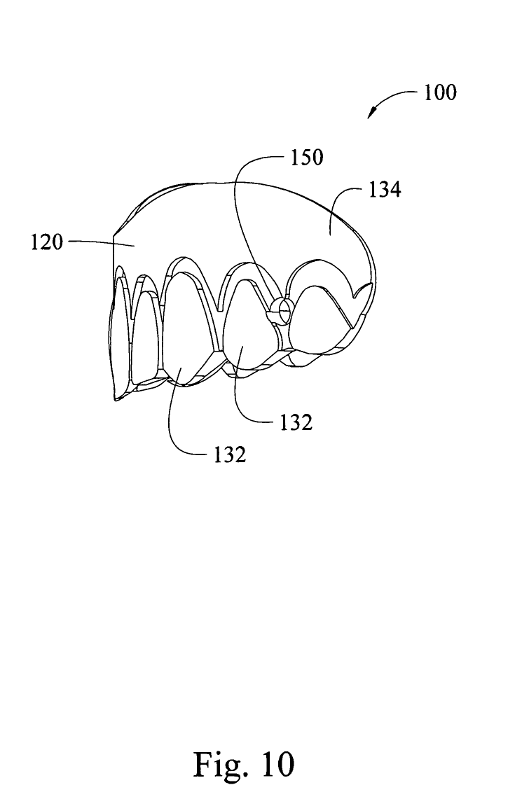

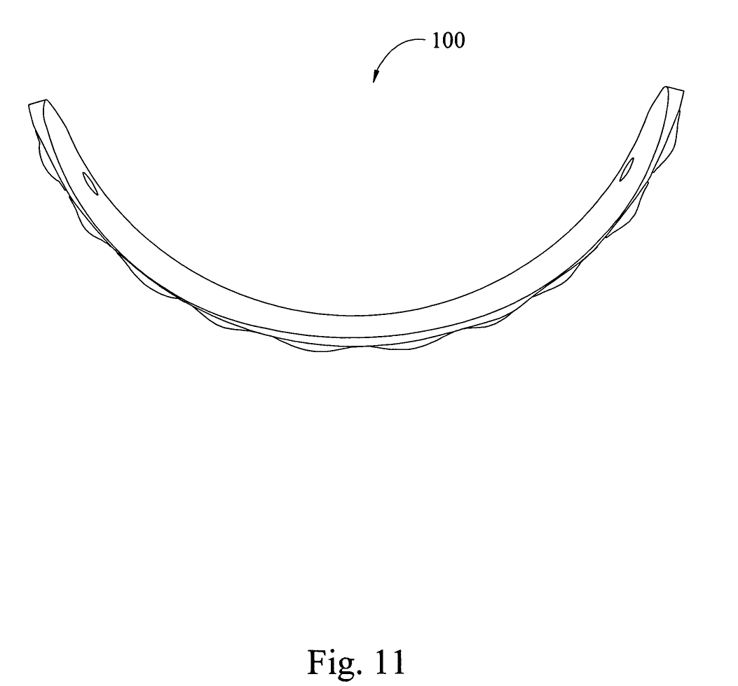

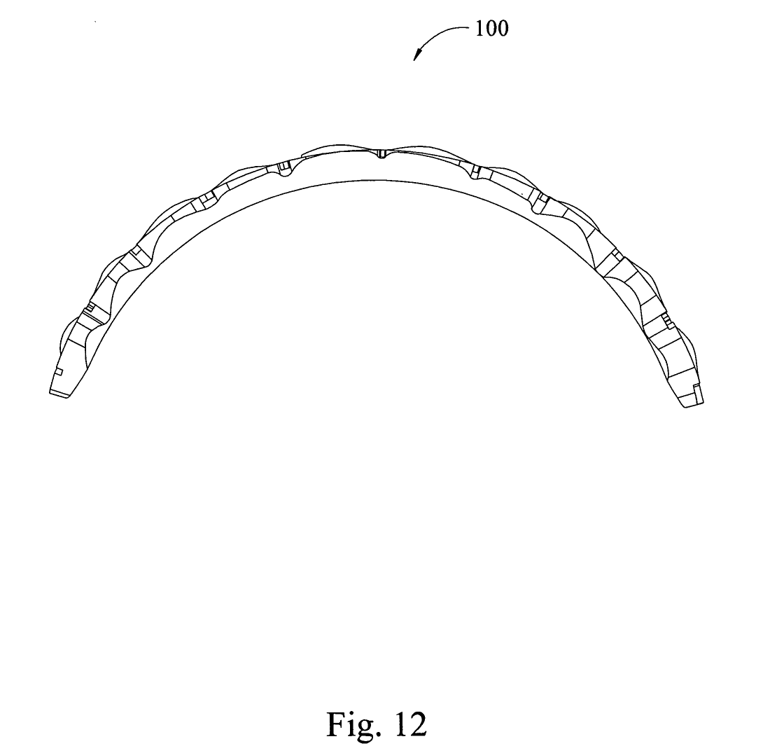

FIGS. 1 through 14 illustrates an exemplary embodiment of a simulated teeth covering 100 embodying one or more aspects of the present disclosure. As shown, the simulated teeth covering 100 generally includes forward and rearward surfaces 120 and 160 respectively facing generally forward and rearward when the simulated teeth covering 100 is positioned within a user's mouth. The simulated teeth covering 100 also includes holes 150 described in more detail herein.

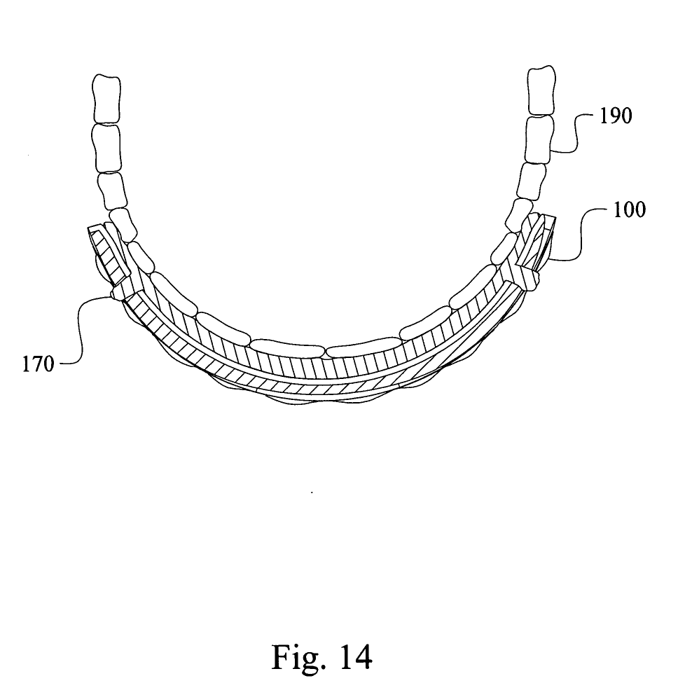

The simulated teeth covering 100 is generally curved so as to substantially correspond with a curvature of a user's natural upper teeth structure. This curvature can allow the simulated teeth covering 100 to be positioned relatively flush against a user's upper teeth structure 190, as shown in FIG. 14. Alternatively, other embodiments can include a simulated teeth covering that is shorter than that shown in the figures. In which case, the shorter simulated teeth covering would extend over the user's upper teeth structure to a lesser degree than what is shown in FIG. 14. Conversely, additional embodiments include a simulated teeth covering that is longer than that shown in the figures. In which case, the longer simulated teeth covering would extend over the user's upper teeth structure to a greater degree than what is shown in FIG. 14.

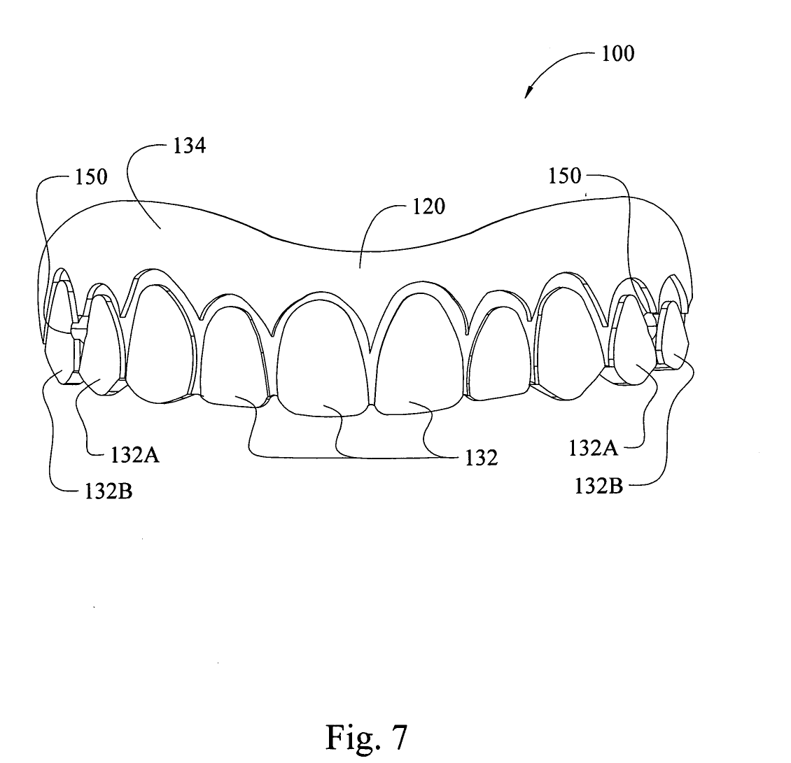

In various preferred embodiments, the forward surface 120 is configured so as to resemble a user's natural teeth structure. For example, FIG. 7 illustrates the forward surface 120 having a particular configuration resembling a human's upper teeth structure. As shown, the forward surface 120 includes ten tooth-resembling portions 132 and a gum-resembling portion 134.

For this particular embodiment of the simulated teeth covering 100, the forward surface 120 is shaped or formed so as to include a three-dimensional realistic appearance of a human's upper teeth structure. That is, the forward surface 120 includes protruding portions, contoured portions, grooves, ridges, etc. to more realistically represent a human's natural teeth structure. These three-dimensional features can be provided during the manufacturing process used for making the simulated teeth covering, such as during an injection molding, manual sculpting process performed by hand, etc. Alternative embodiments may include a forward surface without such three-dimensional features. For example, some embodiments include a generally smooth or flat forward surface where only coloring is used for representing the teeth and gum structures, such as white, off-white, yellow, etc. for the teeth, and pink for the gums.

In some embodiments, coloring is used for enhancing the appearance of the simulated teeth covering 100. For example, some preferred include the tooth-resembling portions 132 that are aesthetically colored (e.g., white, off-white, yellow, etc.) to enhance the realism of the tooth-resembling portions 132. The gum portion 134 can also be aesthetically colored (e.g., pink, etc.) to enhance the realism of the gum portion 134. Some embodiments may provide this aesthetic coloring by painting or otherwise coloring the simulated teeth covering 100 after formation thereof. Alternatively, the aesthetic coloring can be provided during the manufacturing process used for making the simulated teeth covering, or provided afterwards. For example, some embodiments may include using materials having coloring inherent thereto.

Alternatively, the forward surface 120 can be configured in a wide variety of ways besides what is shown in the figures. For example, other embodiments of a simulated teeth covering can include more or less than ten tooth-resembling portions. In additional embodiments, a simulated teeth covering can include a forward surface resembling non-human teeth, such as canine teeth, vampire teeth with fangs, werewolf teeth, etc. In further embodiments, a simulated teeth covering can include a forward surface resembling human teeth in a humorous or other configuration, such as having stains, widely-spaced teeth with gaping holes between teeth, teeth with holes therethrough, braces, gold caps, cavities, radioactive glow, caveman or prehistoric, Billy-Bob® teeth, etc. In still further embodiments, a simulated teeth covering can include a forward surface resembling human teeth having gold-plating and/or jewelry (e.g., a ring suspended from a tooth with a ring, etc.), which may also be referred to as a grill.

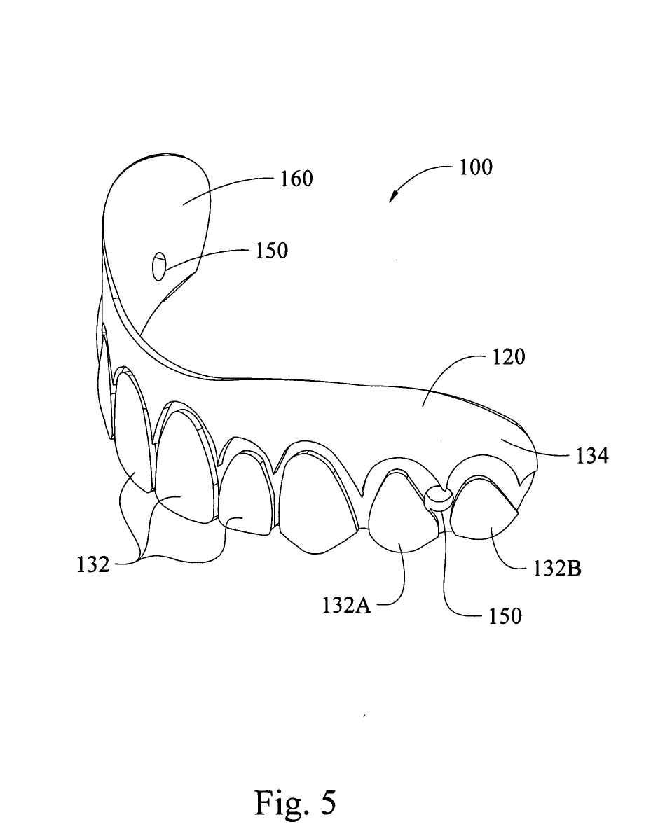

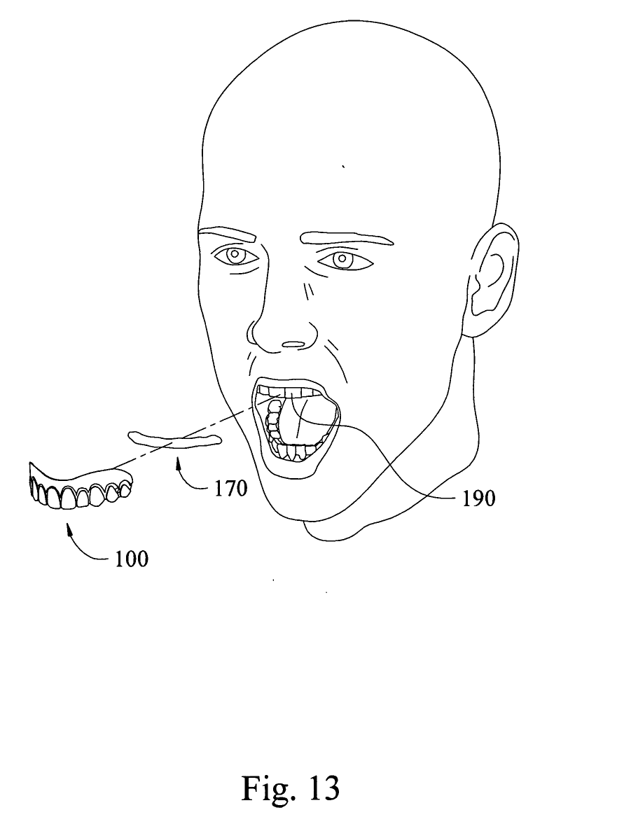

With further reference to FIGS. 5 through 14, the simulated teeth covering 100 also includes holes 150. As shown, the holes 150 extend completely through the thickness of the simulated teeth covering 100 as defined between the forward and rearward surfaces 120, 160. As shown in FIGS. 13 and 14 and described in more detail herein, the holes 150 can be used to form a mechanical or interlocking bond with re-moldable fitting material 170, which, in turn, is used for releasably retaining the simulated teeth covering 100 to a user's existing teeth structure 190.

In various embodiments, the holes 150 are preferably located generally between the most-rearward pair of tooth-resembling portions 132A, 134B along each end portion of the simulated teeth covering 100. As shown in FIGS. 5 and 7, the holes 150 include forward-facing openings at about the interface between the last two tooth-resembling portions 132A, 132B at each end portion of the simulated teeth covering 100. This rearward positioning of the holes 150 makes the holes 150 not readily visible when the simulated teeth covering 100 are being used. For example, the user may be able to smile and/or converse with another person without that other person being able to see the holes 150.

Alternative embodiment can include more or less than two holes and/or holes having other configurations (e.g., shapes, sizes, different locations, diagonally oriented, slanted, etc.). For example, other embodiments can include holes that are non-circular (e.g., rectangular, triangular, star-shaped, etc.). Further embodiments can include openings (e.g., blind-holes, etc.) that do not extend completely through the thickness of the simulated teeth covering.

A wide range of materials can be used for making the simulated teeth covering 100. In one particular embodiment, the simulated teeth covering 100 is formed from polyresin material. Alternative materials can also be used, such as injection moldable plastic materials, etc., depending, for example, on the particular manufacturing process employed for making the simulated teeth covering 100.

The simulated teeth covering 100 can be made via a wide range of manufacturing processes. In various embodiments, the simulated teeth covering 100 is formed via an injection molding process. In such embodiments, the holes 150 can be integrally formed during the molding process, for example, by structure provided within the injection molding cavity for forming the holes 150. Alternatively, the holes 150 may be formed post-molding, such as by drilling the holes 150, etc. As another example, the simulated teeth covering 100 may also be formed manually via a sculpting process. In such embodiments, the holes 150 can be formed by drilling, etc. Still other manufacturing methods (e.g., casting, blow molding, hot or cold compression molding, transfer molding, cold molding, jet molding, vacuum forming, thermoforming, among others) and other configurations (e.g., shapes, sizes, materials, etc.) can be used for making and/or forming a simulated teeth covering.

For purposes of illustration only, the following description is provided of an exemplary method by which the simulated teeth covering 100 may be attached to a user's existing teeth structure 190 by using re-moldable fitting material 170. By way of example, the re-moldable fitting material 170 may comprise thermal fitting plastic beads commercially available from Billy-Bob Teeth, Inc., etc. Alternatively, other suitable materials can be used, such as those suitable for use in the dental industry.

With reference to FIGS. 13 and 14, the simulated teeth covering 100 is placed into hot water for about one minute to soften the polyresin material (or other suitable material(s)) from which the simulated teeth covering 100 is formed. With the material pliable and conformably moldable, the simulated teeth covering 100 is pressed against the user's existing upper teeth structure 190, preferably with sufficient force for bending the simulated teeth covering 100 so that its curvature generally conforms to the user's existing teeth structure 190.

Next, re-moldable fitting material 170 is heated until the re-moldable fitting material changes from its initial white color to substantially clear. By way of example only, the re-moldable fitting material 170 can be heated by placing it into a cup of boiling or very hot water. Depending on the water temperature, it may take approximately one minute for the color change to occur in the re-moldable fitting material 170. After the color change, the re-moldable fitting material 170 is removed from the hot water, such as with a spoon. The user then molds or rolls the re-moldable fitting material 170 into a generally worm-like shape as shown in FIG. 13. The re-moldable fitting material 170 is dried off (e.g., using a paper napkin, etc.).

The re-moldable fitting material 170 is pressed against the rearward surface 160 of the simulated teeth covering 100. Sufficient pressure is applied to the re-moldable fitting material 170 (e.g., by using the fingers, etc.) to squeeze or force some of the re-moldable fitting material 170 into and through the holes 150. As shown in FIG. 14, it is generally preferred to have the holes 150 substantially entirely filled with the re-moldable fitting material 170 and to have at least some re-moldable fitting material 170 disposed on the forward surface 120 of the simulated teeth covering 100. Preferably, the user also manipulates the re-moldable fitting material 170 such that it is distributed along the rearward surface 160 with a thickness varying from relatively thin at about the upper edge of the simulated teeth covering 100 to relatively thick at about the lower edge of the simulated teeth covering 100.

The simulated teeth covering 100 (with the re-moldable fitting material 170 thereon) is placed into the user's mouth. The user's existing teeth are moved relatively towards the simulated teeth covering's rearward surface 120 and through the re-moldable fitting material 170 thereon. Excess re-moldable fitting material is pushed against the roof of the user's mouth (e.g., by using the tongue, etc.). The simulated teeth covering 100 is brought tightly against the user's existing teeth structure 190 to form an impression thereof in the re-moldable fitting material 170 that is disposed on the simulated teeth covering's rearward surface 160. The simulated teeth covering 100 (and re-moldable fitting material 170 thereon) is gently removed from the user's mouth, and allowed to cool for at least about ten minutes. During this cooling process, the re-moldable fitting material 170 may change in color back to its initial white color. If the user is not satisfied with the end result (e.g., the impression, etc.), this process may be repeated until a satisfactory result is achieved. At which point, the satisfied user may remove or trim excess re-moldable fitting material 170 from the simulated teeth covering 100. During the exemplary process described in this paragraph, the user should not leave the simulated teeth covering 100 in his or her mouth for more than about one minute, so as to avoid having the re-moldable fitting material 170 cool and harden while in the user's mouth. If that happens, hot water or a dentist may be needed to remove the simulated teeth covering 100 from the user's mouth.

Some embodiments of the simulated teeth covering do not include a bottom trough portion. This is in contrast to the fake teeth 10 (shown in FIGS. 1 through 4), which have a bottom trough portion 40. While the fake teeth 10 have worked well for their intended purpose, the inventor hereof has recognized that eliminating the bottom trough portion in some embodiments can allow the simulated teeth covering to be produced using less material. The inventor hereof has also recognized that eliminating the bottom trough portion can also facilitate the manufacture of simulated teeth covering, for example, by allowing a less complex molding cavity to be used for injection molding simulated teeth coverings. The inventor hereof has further recognized that some users may find it more comfortable to wear a simulated teeth covering that does not have a bottom trough portion. Alternative embodiments, however, include simulated teeth coverings with one or more generally forward-facing through-holes and a bottom shelf or trough portion.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order or performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A simulated teeth covering for attachment to a user's existing teeth structure, the simulated teeth covering comprising a forward surface, a rearward surface, and at least one hole extending generally from the rearward surface to the forward surface.

2. The simulated teeth covering of claim 1, further comprising re-moldable fitting material having a first portion disposed on at least a portion of the rearward surface, a second portion disposed within the at least one hole, and a third portion disposed on at least a portion of the forward surface, thereby at least partially forming at least one bond mechanically retaining the re-moldable fitting material to the simulated teeth covering.

3. The simulated teeth covering of claim 2, wherein the first portion of the re-moldable fitting material includes an impression of at least a portion of a user's existing teeth structure for frictional engagement therewith, whereby the at least one bond and the frictional engagement of the at least a portion of the user's existing teeth structure within the impression can cooperatively retain the simulated teeth covering to the user's existing teeth structure.

4. The simulated teeth covering of claim 1, further comprising re-moldable fitting material having:
at least a first portion disposed on at least a portion of the rearward surface, and including an impression of at least a portion of a user's existing teeth structure for frictional engagement therewith; and
at least a second portion disposed within the at least one hole, and at least partially forming at least one bond mechanically retaining the re-moldable fitting material to the simulated teeth covering,

5. The simulated teeth covering of claim 1, further comprising re-moldable fitting material disposed within the at least one hole.

6. The simulated teeth covering of claim 5, further comprising at least one bond formed generally between at least a portion of the simulated teeth covering and re-moldable fitting material disposed within the at least one hole.

7. The simulated teeth covering of claim 5, wherein the re-moldable fitting material comprises plastic.

8. The simulated teeth covering of claim 1, wherein the simulated teeth covering defines a generally C-shape when viewed from above or below.

9. The simulated teeth covering of claim 1, further comprising top and bottom edges with substantially identical C-shaped curvatures when respectively viewed from above and below.

10. The simulated teeth covering of claim 1, wherein the simulated teeth covering does not include a bottom trough portion.

11. The simulated teeth covering of claim 1, wherein the at least one hole extends completely through the entire thickness of the simulated teeth covering as defined between the forward surface and the rearward surface.

12. The simulated teeth covering of claim 1, wherein the at least one hole extends from the rearward surface only partially through the thickness of the simulated teeth covering as defined between the forward surface and the rearward surface.

13. The simulated teeth covering of claim 1, wherein the forward surface is configured to resemble a human teeth structure with at least one substantially white portion configured to resemble one or more human teeth and at least one substantially pink portion configured to resemble human gums.

14. The simulated teeth covering of claim 1, wherein the forward surface includes a plurality of tooth-resembling portions, and wherein the at least one hole includes a forward-facing opening located at about the interface between an adjacent pair of the tooth-resembling portions.

15. The simulated teeth covering of claim 1, wherein the forward surface includes a plurality of tooth-resembling portions, and wherein the at least one hole includes a forward-facing opening adjacent the most-rearward tooth-resembling portion.

16. The simulated teeth covering of claim 1, further comprising a first end portion, a second end portion, and a medial portion curving generally from the first end portion to the second end portion with a curvature corresponding to a curvature of a human teeth structure, and wherein the at least one hole comprises a first hole adjacent the first end portion, and a second hole adjacent the second end portion.

17. The simulated teeth covering of claim 16, further comprising a plurality of tooth-resembling portions disposed generally along the forward surface from the first end portion along the medial portion to the second end portion, wherein the first hole includes a forward-facing opening at about the interface between the most-rearward pair of tooth-resembling portions along the first end portion, and wherein the second hole includes a forward-facing opening at about the interface between the most-rearward pair of tooth-resembling portions along the second end portion.

18. A method of attaching a simulated teeth covering to a user's existing teeth structure, the method comprising engagingly receiving at least a portion of the user's existing teeth structure within an impression formed in a first portion of re-moldable fitting material on a rearward surface of the simulated teeth covering, the re-moldable fitting material also having a second portion disposed within at least one hole extending generally from the rearward surface to the forward surface thereby at least partially forming at least one bond mechanically retaining the re-moldable fitting material to the simulated teeth covering, whereby the at least one bond and the engagement of the at least a portion of the user's existing teeth structure within the impression cooperatively retain the simulated teeth covering to the user's existing teeth structure.

19. The method of claim 18, further comprising heating the re-moldable fitting material, and positioning the heated re-moldable fitting material generally against the rearward surface of the simulated teeth covering with sufficient pressure for causing at least a portion of the heated re-moldable fitting material to enter the at least one hole.

20. The method of claim 19, further comprising making the impression by positioning the simulated teeth covering within the user's mouth such that the heated re-moldable fitting material on the rearward surface of the simulated teeth covering contacts the at least a portion of the user's existing teeth structure with sufficient pressure for making the impression in the re-moldable fitting material.

21. The method of claim 19, wherein sufficient pressure is applied to the heated re-moldable fitting material such that at least a portion thereof is forced into and out of the at least one hole onto the forward surface of the simulated teeth covering.

22. The method of claim 19, further comprising shaping the heated re-moldable fitting material into a generally worm-like shape before positioning the heated re-moldable fitting material generally against the rearward surface of the simulated teeth covering.

23. The method of claim 19, further comprising removing the simulated teeth covering from the user's mouth after making the impression, and allowing the heated re-moldable fitting material to cool.

24. The method of claim 18, further comprising heating the simulated teeth covering, and then positioning the heated simulated teeth covering against the user's existing teeth structure to impart a curvature to the simulated teeth covering corresponding to the curvature of the user's existing teeth structure.

25. A method for making a simulated teeth covering having a forward surface and a rearward surface, the method comprising forming at least one hole extending generally from the rearward surface to the forward surface.

26. The method of claim 25, wherein forming at least one hole comprises drilling the at least one hole.

27. The method of claim 25, wherein forming at least one hole comprises forming the at least one hole during an injection molding process used for making the simulated teeth covering.

28. The method of claim 25, further comprising coloring the forward surface to resemble a human teeth structure including one or more teeth and gums.

29. The method of claim 25, further comprising heating re-moldable fitting material, and positioning the heated re-moldable fitting material generally against the rearward surface of the simulated teeth covering with sufficient pressure for causing at least a portion of the heated re-moldable fitting material to enter the at least one hole.

30. The method of claim 29, wherein sufficient pressure is applied to the heated re-moldable fitting material such that at least a portion thereof is forced into and through the at least one hole onto the forward surface of the simulated teeth covering.

31. The method of claim 29, further comprising making an impression in the heated re-moldable fitting material on the rearward surface of the simulated teeth covering by contacting at least a portion of the user's existing teeth structure.

32. The method of claim 25, further comprising heating the simulated teeth covering, and positioning the heated simulated teeth covering against the user's existing teeth structure to impart a curvature to the simulated teeth covering corresponding to the curvature of the user's existing teeth structure.
